(19) United States
(12) Patent Application Publication
(10) Pub. No.: US 2007/0110842 A1
(43) Pub. Date: May 17, 2007

(54) System for molding and assembly of sterilized articles

(75) Inventor: Jacek Kalemba, Oakville (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/274,543

(22) Filed: Nov. 15, 2005

(51) Int. Cl. B29C 45/38

(52) U.S. Cl. 425/554

(57) ABSTRACT

Disclosed is a system. The system includes a molding machine configured to cooperate with a mold to mold a first part and a second part. The molding machine is also includes an assembly mechanism configured to interlock the first part with the second part. Other aspects contemplate combinations and permutations of the aspect described above.

### TECHNICAL FIELD OF THE INVENTION

The present invention generally relates to molding systems, and more particularly the present invention relates to a system that includes a combination and permutation of a molding machine, a mold, a sterilization mechanism, and an assembly mechanism for assembling molded articles.

### BACKGROUND

Nothing in the following description in the background will be construed as an admission of prior art.

The state of the art includes various devices and methods for removing molded parts from multicavity molds. When the molded part includes a container and a lid, sometimes it may be desirable to attach the lid to the container before the container is removed from the molding machine. Attaching the lid to the container immediately after molding can maintain the sterility of the interior of the container.

U.S. Pat. No. 4,976,603 (Inventor: Disimone; Assignee: Husky Injection Molding Systems Limited, Canada), U.S. Pat. No. 5,518,387 (Inventor: Disimone; Assignee: Husky Injection Molding Systems Limited, Canada), and U.S. Pat. No. 5,709,833 (Inventor: Disimone; Assignee: Husky Injection Molding Systems Limited, Canada) disclose mechanisms for removing molded parts that do not significantly increase molding cycle time and that utilize pivoting arms having suction devices thereon to unload molded parts. These patents are directed to part ejection systems that use a pivoting arm attached to one of the mold plates to enter an open mold space, capture an ejected molded part and transport it to a position adjacent the mold so the part can be released.

U.S. Pat. No. 5,037,597 (Inventor: McGinley et al; Assignee: Husky Injection Molding Systems Limited, Canada) discloses an apparatus for assembling two parts within a stack mold. The parts are retrieved from the molding surface by vacuum cups attached to pivoting arms. The arms are rotated one hundred and eighty degrees in the mold to move the parts into an assembled position (that is, an interlocked position). When in the assembled position, the vacuum to the vacuum cups is removed and the assembled parts are permitted to drop down a chute in the mold onto a conveyor for transporting the assembled parts away from the molding machine.

U.S. Pat. No. 6,145,277 (Inventor: Lawecki et al; Assignee: Medrad, USA) discloses apparatus for forming parts in an injection molding machine with a clean environment incorporated around the mold. The formed parts are transferred to an inspection station and then to an assembly station in the clean environment.

U.S. Pat. No. 5,378,422 (Inventor: Musiel et al; Assignee: S. C. Johnson & Son, Inc., USA) discloses using a mechanism to fit two molded parts together in the mold.

U.S. Pat. No. 3,685,933 (Inventor: Schneider; Assignee: Firma Werner & Mertz GmbH, Germany), WO Patent 0228622A1 (Inventor: Christinger; Assignee: Schöttli Ag, Industrie, Switzerland), U.S. Pat. No. 4,476,083 (Inventor: von Holdt; Assignee: not assigned), and WO Patent 2004/041507A2 (Inventor: Vanderploeg et al; Assignee: Husky Injection Molding Systems Limited, Canada) disclose molding machines that provide a mold that maintains a hinged connection between the parts.

U.S. Pat. No. 5,043,126 (Inventor: Thurau; Assignee: Frank Plastic GmbH, Germany) discloses a process where a first part is molded around a second part.

U.S. Pat. No. 6,692,684 (Inventor: Nantin et al; Assignee: Tetra Laval Holdings & Finance S. A., Switzerland) U.S. Pat. No. 5,141,430 (Inventor: Maus et al; Assignee: Galic Maus Ventures, USA) and U.S. Pat. No. 4,880,581 (Inventor: Dastoli et al; Assignee: Alcon Laboratories, Inc., USA) disclose methods for maintaining a sterile environment around the molded parts sterile. These prior art methods need sterilization of a subsequent environment where the molded parts are removed from the molding machine for assembly or other operations.

US Patent Application 20040113328A1 (Inventor: Hekal; Assignee: not assigned) discloses an improved method for sterilization of biaxial-oriented, hollow thermoplastic preforms and a process of molding thermoplastic preforms into bottles and similar containers in which pressurized liquids, such as water, are used in the stretching and shaping process rather than pneumatic gases, such as heated air. The result is greater control over crystallizing the thermoplastic material and economies of scale. Peroxides, or similar materials, may be used for sterilization can be added to the liquid thereby conditioning the container for immediate filling with a product and eliminating the need for an added sterilization step following completion of the molding step. As an added step, dry, sterile air can be used to vent and dry the container just before introduction of the product. Also use of a liquid rather than heated air provides a washing or cleansing of acetaldehydes or ethanol, which may be present in the extruded preform.

US Patent Application 20040052891A1 (Inventor: Kalemba et al; Assignee: Husky Injection Molding Systems Limited, Canada) discloses an injection molding apparatus for closing hinged molded part, and the apparatus includes a part-removal apparatus that grips a molded lid and/or a molded container. The apparatus for folding a hinged molded part in a molding machine is also described. As the part-removal apparatus moves the lid out of the mold, a deflector (connected to the mold) engages a container and begins folding the lid to the container at the hinge. The deflector further folds the lid and the container as the mold closes.

U.S. Pat. No. 5,344,305 (Inventor: McKillip; Assignee: CCL Label, Inc., USA) discloses a method and apparatus for in-mold labeling in which labels are individually cut from a continuous web as demanded by the cycling of a mold. The web of labels is advanced through a die cutter which sequentially cuts individual labels from the web. A transfer device picks a freshly cut label from the die cutter and places the label in the cavity of a mold found proximal to the die cutter. By individually cutting labels from a web at the time of use rather than loading a stack of precut labels in a magazine, this arrangement permits using thinner, less expensive and compatible plastic label material.

U.S. Pat. No. 4,872,304 (Inventor: Thompson; Assignee: Tri-Tech Systems International Inc., USA) discloses a container and a cap and a method of forming the cap. In the method the cap is molded from plastic and includes a top well, an outer depending skirt and an internal depending substantially annular wall having an upper end integral with and depending from the top wall and a lower free end. The free end is engaged by a curling tool to progressively turn the free end away from the internal wall to curve the free end into a curvilinear compressible and resilient free end adapted to be engaged for sealing.

U.S. Pat. No. 4,026,982 (Inventor: Dardaine et al; Assignee: E. P. Remy et Cie, France) discloses a process for supplying sterile gas to an extruded parison confined between the two shells of a mold. The sterile gas is sequentially applied at a first pressure slightly higher than atmospheric pressure, at a second pressure much higher than the first pressure which inflates the parison, and at a third pressure that is much lower than the second pressure and corresponds to the desired inflating pressure of the hollow body to be formed.

U.S. Patent Application No. 20040052891A1 (Inventor: Kalemba et al; Assignee: Husky Injection Molding Systems Limited, Canada) discloses An apparatus and method for folding a hinged molded part in a molding machine. As a part-removal apparatus, preferably a swing arm mechanism, grips one of the lid portion or the base portion of the molded part and moves the molded part out of the mold, a deflector connected to a portion of the mold engages the other portion of the part and initiates folding of the lid portion to the base portion at the hinge. The deflector further folds the part as the mold closes. The portions of the part are pushed together and latched in one embodiment by the swing arm mechanism that grips and moves the molded part against the deflector, and in another embodiment by a closing actuator operated separately from the swing arm mechanism.

Handling of the parts in the mold may expose molded components to the atmosphere long enough to degrade sterility of the molded components to unacceptable levels. Therefore the components (containers and lids) are molded, collected into boxes, assembled, stored and then they are sterilized after assembly (for example, 1 to 3 months after molding the components) by subjecting the components to gamma radiation or placing the components in a container that is flooded with a decontamination gas such as ethylene oxide for several hours. This extra step of sterilization adds considerable expense to producing sterilized molded components.

### SUMMARY

According to a first aspect of the present invention, there is provided a system, including a molding machine configured to cooperate with a mold to mold a first part and a second part, the second part interlockable with the first part, the second part molded separately from the first part, and also including an assembly mechanism configured to interlock the first part with the second part.

According to a second aspect of the present invention, there is provided a system, including a molding machine configured to cooperate with a mold to mold a first part and a second part, the second part interlockable with the first part, the second part molded separately from the first part, and also configured to cooperate with an assembly mechanism, the assembly mechanism configured to interlock the first part with the second part.

According to a third aspect of the present invention, there is provided a system, including an assembly mechanism configured to interlock a first part with a second part, the first part and the second part molded by a molding machine configured to cooperate with a mold to mold the first part and the second part, the second part interlockable with the first part, the second part molded separately from the first part.

According to a fourth aspect of the present invention, there is provided a system, including a molding machine having a molding machine-envelope, the molding machine configured to cooperate with a mold to mold a first part and a second part, the second part interlockable with the first part, the second part molded separately from the first part, and including a sterilization mechanism having a sterilization envelope, the sterilization mechanism configured to maintain, in association with the molding machine-envelope, the first part and the second part sterilized, and also including an assembly mechanism configured to assemble, in association with the sterilization envelope, the first part with the second part.

The technical advantage of the present invention is improved way to interlock molded parts with each other.

### BRIEF DESCRIPTION OF DRAWINGS

A better understanding of the exemplary embodiments of the present invention (including alternatives and/or variations thereof) may be obtained by referring to the detailed description of the exemplary embodiments with the following drawings, in which:

FIG. 1A is a cross-sectional view of a system including a mold, an assembly mechanism and a sterilization mechanism and a perspective view of a molding machine according to a first embodiment of the present invention;

FIG. 1B is a perspective view of the sterilization mechanism of FIG. 1A according to a variation of the first embodiment;

FIG. 1C is a cross-sectional view of the mold and the assembly mechanism of FIG. 1A, in which the mold is placed in a mold-closed position;

FIG. 2 is a cross-sectional view of the mold and the assembly mechanism of FIG. 1A (in which the mold is placed in placed in a mold-open position;

FIG. 3 is a partial cross-sectional view of the mold and the assembly mechanism of FIG. 1A;

FIG. 4 is a cross-sectional elevation view of the mold of FIG. 1C;

FIG. 5 is a partial end view of the mold of FIG. 1C;

FIG. 6 is another partial end view of the mold of FIG. 1C;

FIG. 7 is a cross-sectional view of the mold and the assembly mechanism of FIG. 1A according to the second embodiment; and

FIG. 8 is a perspective view of the system of FIG. 1A.

The drawings are to scale and are sometimes illustrated by phantom lines, diagrammatic representations and fragmentary views. In instances, details that are not needed for an understanding of the embodiments or that give other details difficult to perceive may have been omitted.

### DETAILED DESCRIPTION OF THE EXEMPLARY EMBODIMENTS

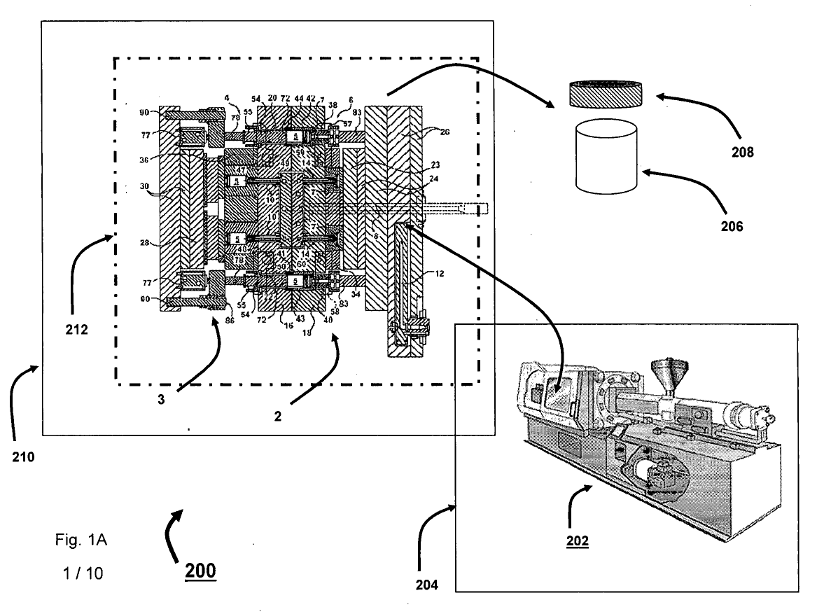

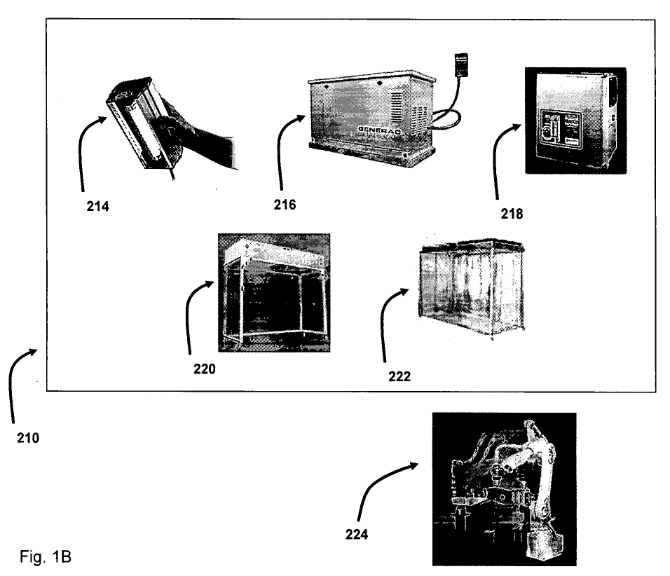

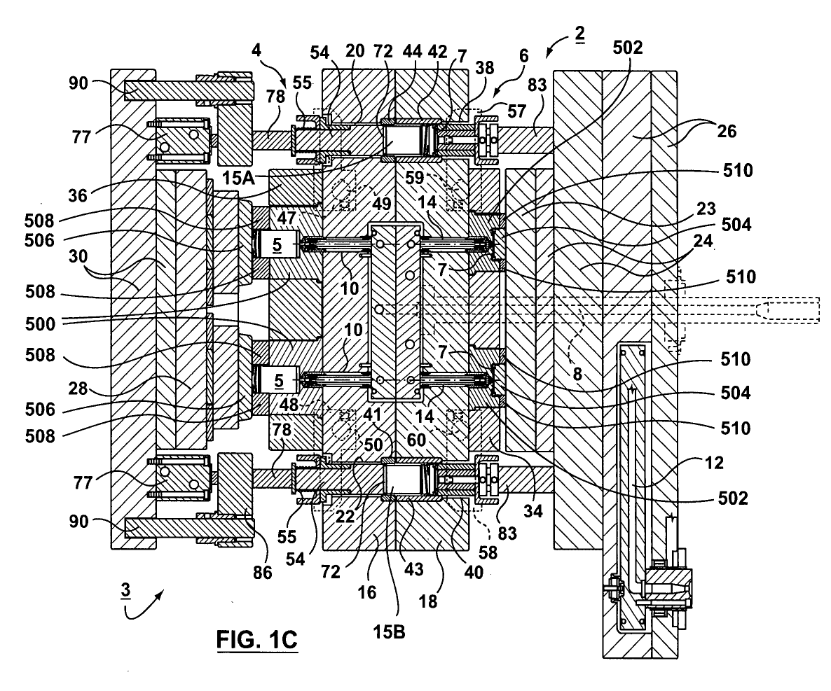

FIG. 1A illustrates a system 200 having a mold 2, an assembly mechanism 3 and a sterilization mechanism 210, all according to the first embodiment of the present invention. The system 200 includes a molding machine 202 configured to cooperate with the mold 2, the sterilization mechanism 210 and the assembly mechanism 3. Preferably, the molding machine 202, the mold 2, the sterilization mechanism 210 and the assembly mechanism 3 are all manufactured and assembled by a single vendor. According to a variation of the first embodiment, the molding machine 202, the mold 2, the sterilization mechanism 210 and the assembly mechanism 3 are all assembled by a combination and permutation of a plurality of vendors, and these items are assembled at a factory by a system integrator.

The molding machine 202 has or defines a molding-machine envelope 204. The molding machine 202 cooperates, in use, with the mold 2 to mold a first part 206 and a second part 208. The second part 208 is interlockable with the first part 206, and the second part 208 is molded separately from the first part206. It is contemplated that the molding-machine envelope 204 may be larger or may be smaller than the size of the molding machine 202. In a variation, the molding-machine envelope 204 defines a boundary that is up to 2 or 3 metres outwardly offset from the perimeter of the molding machine 202. According to the first embodiment, the molding-machine envelope 204 matches the perimeter of the molding machine 202.

In an alternative, the first part 206 is a container and the second part 208 is a lid 10 that covers the container. In another alternative, the first part 206 is a urine-sample collection container and the second part 208 is a cap used to cover the urine-sample collection container. Other types of parts are contemplated for the first part 206 and the second part 208.

The sterilization mechanism 210 has or defines a sterilization envelope 212. The sterilization mechanism 210 maintains, when so actuated and in association with the molding-machine envelope 204, the first part 206 and the second part 208 sterilized. It is contemplated that the sterilization envelope 212 may be larger, smaller or the same size as the size of the sterilization mechanism 210. For example, the perimeter of the sterilization envelope 212 may define a boundary that is up to 1 or 2 metres outwardly offset from the perimeter of the sterilization mechanism 210. It is preferred that the sterilization envelope 212 is associated with the molding-machine envelope 204 in that they overlap in part (as shown in FIG. 1B). In an alternative, the sterilization envelope 212 is associated with the molding-machine envelope 204 in that they are offset from each other and do not mutually overlap (for example, the offset between these envelopes is contemplated to be up to 2 metres). In another alternative, the sterilization envelope 212 is larger than the molding-machine envelope 204 (for example, such as up to 1 meter larger than the molding-machine envelope 204); while in another variation the sterilization envelope 212 is smaller than the molding-machine envelope 204.

The assembly mechanism 3, in use, assembles, in association with the sterilization envelope 212, the first part 206 with the second part 208. In a variation, the assembly mechanism 3 remains entirely enclosed by the sterilization envelope 212. In another variation, the assembly mechanism 3 remains partly enclosed by the sterilization envelope 212. According to the first embodiment, the mold 2 is combined with the assembly mechanism 3. In a variation, the mold 2 and the assembly mechanism 3 are not combined with each other. The assembly mechanism 3, according to the first embodiment, does not place a sealing label onto the first part 206 assembled to the second part 208.

According to a variation, the first part 206 defines a first thread configured to threadably interlock with a second thread defined by the second part 208, and the assembly mechanism 3, in use, assembles or interlocks the first thread of the first part relative to the second thread of the second part. It is contemplated that the assembly mechanism 3 assembles the first and second threads by performing any one of the following (in any combination and permutation thereof): snap fit the first thread relative to the second thread, and torque the first thread relative to the second thread.

According to a variation, the assembly mechanism 3, in use, assembles the first part 206 with the second part 208 in the molding-machine envelope 204. The sterilization mechanism 210 is configured to impose a sterile condition on the molding-machine envelope 204 defined by the mold 2.

FIG. 1B is the view of the sterilization mechanism 210 of FIG. 1A according to a variation of the first embodiment, in which the sterilization mechanism 210 includes any one of an ultraviolet lamp 214, a sterilized-air mover 216, an air mover 218, a clean-room enclosure 220, clean-room barrier 222 and any combination and permutation thereof. The ultraviolet lamp 214, in use, directs ultraviolet light toward the first part 206 and the second part 208. The sterilized-air mover 216, in use, moves sterilized air toward the first part 206 and the second part 208. The air mover 218, in use, moves air, and the moved air substantially displaces bacteria away from the first part 206 and the second part 208. The clean-room enclosure 220, in use, substantially prevents, at least in part, ingress of bacteria into the molding-machine envelope 204, the sterilization envelope 212 and any combination and permutation thereof. The clean-room barrier 222, in use, substantially prevents ingress of bacteria, at least in part, into the molding-machine envelope 204 and/or the sterilization envelope 212 and/or any combination and permutation thereof.

According to another variation, the assembly mechanism 3 is operatively connectable to any one of the mold 2, an end-of-arm-tool of a robot 224 (depicted in FIG. 1B), any combination and permutation thereof.

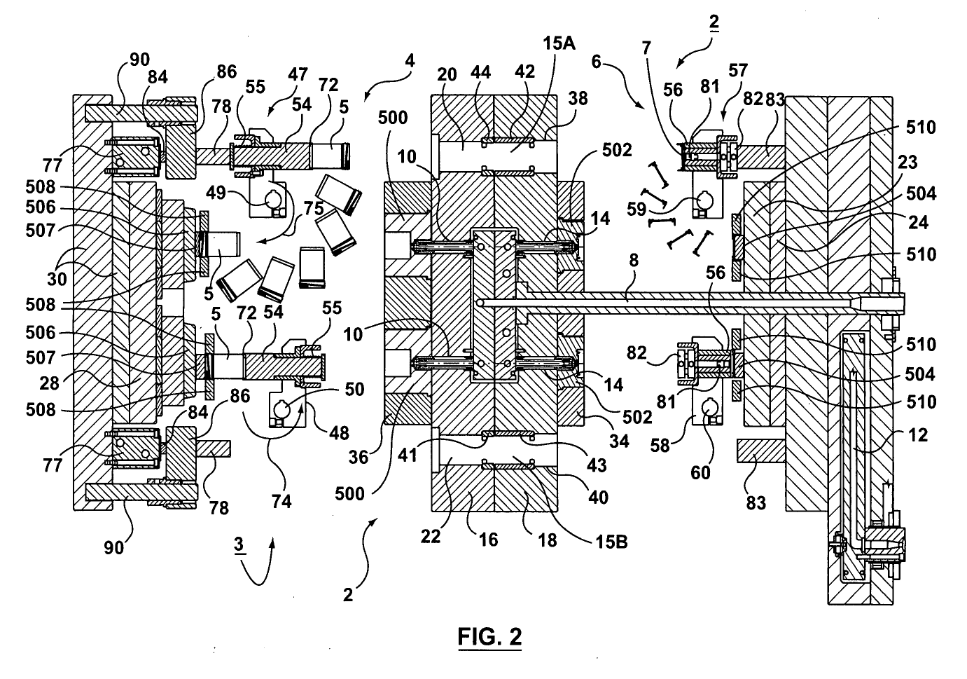

According to the first embodiment, two injection units of the molding machine 202 of FIG. 1A are used to inject different molding material for the first part 206 and the second part 208. FIG. 2 depicts two separate injection paths for carrying different molding materials, one for each of the containers and lids to be molded. According to an alternative, the molding machine 202 of FIG. 1A uses one injection unit to provide one molding material used to form the first part 206 and the second part 208.

FIG. 1C is the sectional view of the mold 2 and the assembly mechanism 3 of FIG. 1A, in which the mold 2 is placed in a mold-closed position. For sake of simplifying the description of the first embodiment, the first body 206 will hereafter be referred to as the “container 5”, and the second body 208 will hereafter be referred to as the “lid 7”. The assembly mechanism 3 includes a first swing-arm assembly (58 or 57) configured to pick up, swing and translate the container 5 toward the lid 7. The assembly mechanism 3 also includes a second swing-arm assembly (48 or 47) configured to pick up, swing and translate the lid 7 toward the container 5. For the sake of simplifying the description of the embodiments and their alternatives, hereafter, the first swing-arm assemblies (58, 57) will be referred to as the “assemblies” (58, 57), and the second swing-arm assemblies (48, 47) will be referred to as the “assemblies” (48, 47).

The mold 2 includes a container-mold set 4 adapted to mold a set of containers 5. The mold 2 also includes a lid-mold set 6 adapted to mold a set of mold lids 7. To form the set of containers 5, the molding machine 202 injects a first molding material (not depicted) through an injection channel 8 that leads into injection nozzles 10, then into the container-mold set 4. The first molding material includes a plastic resin that is (preferably) translucent when molded. To form the set of lids 7, the molding machine 202 injects a second molding material (not depicted) through injection channel 12 that leads into injection nozzles 14, then into the lid-mold set 6. The second mold material includes a plastic resin that is (preferably) opaque when molded.

Containers and lids that were molded during a previous molding cycle of the molding machine 202 are moved or retrieved by the assembly mechanism 3 into chutes 15A and 15B. The chutes 15A and 15B are formed by the mold 2. The retrieved containers 5 and lids 7 were retrieved by swing-arm assemblies 47, 48, 57 and 58 whose operation is described below.

The container-mold set 4 includes container-cavity plate 36 that is attached to a center-manifold plate 16. The plate 36 is configured to receive a container-cavity insert 500. The container-mold set 4 also includes a container-core plate 30 that is attached to a movable platen (not shown) of the molding machine 202. The container-core plate 506 is configured to attached to a container core (not depicted in FIG. 1C because the container core is hidden in the container 5; however, the container core is identified at item 507 in FIG. 2). The container core and the container cavity insert cooperate to define a cavity for molding the container 5. The center-manifold plate 16 defines apertures 20 and 22 configured to cooperate with a swing-arm assembly 47 and a swing-arm assembly 48 respectively. The assemblies 47, 48 are used to handle the containers 5. The assemblies 47, 48 are components included with the assembly mechanism 3. Container strippers 508 are used to strip or remove the container 5 from the container core once the container is molded and the container-cavity inserts 500 are moved away from the core plate 506. Strippers 508 are actuated to move side to side.

The lid-mold set 6 includes lid-cavity plate 34 that is attached to a center-manifold plate 18. The plate 34 is configured to receive a lid-cavity insert 502. The lid-mold set 6 also includes core plates 24 that are attached to a fixed-manifold plate 26. The plate 24 is configured to attached to lid core 504. The lid-cavity insert 502 and the lid core 504 cooperate to define a molding cavity for molding the lids 7. The center-manifold plates 16, 18 are affixed to one another. The center-manifold plate 18 defines an aperture 38 and an aperture 40. The apertures 38, 40 receive swing-arm assemblies 57, 58 respectively. The assemblies 57, 58 are used to handle the lids 7. The assemblies 57, 58 are components included with the assembly mechanism 3. Lid strippers 510 are used to strip or remove the lid 7 from the lid core 504 once the lid is molded and the lid-cavity inserts 502 are moved away from the lid cores 504. The strippers 510 are acutated to move side to side.

Internal ends 42, 44 of the aperture 20 are interconnected to define the downwardly-extending chute 15A. Internal ends 41, 43 of the aperture 22 are interconnected to define the downwardly-extending chute 15B. The chutes 15A, 15B permit a way to pass or convey containers assembled to their lids, which is described below. For the sake of simplifying the description of the first embodiment, some components identified in FIG. 1C were not described above but a description of these components will be provided below.

FIG. 2 is the sectional view of the mold 2 and the assembly mechanism 3 of FIG. 1C, in which the mold 2 is placed in a mold-opened position. The container-mold set 4 is associated with the swing-arm assemblies 47, 48. Also the lid-mold set 6 is associated with the swing-arm assemblies 57, 58. The swing-arm assemblies 47 and 48 are used to pick and rotate their containers 5 about pivot positions 49 and 50 respectively. Once the mold 2 is opened (by movement of the movable platen), the swing-arm assemblies 47 and 48 are actuated to rotate one hundred and eighty degrees from an out-of-mold position to an in-mold position (that is, it is a position within a molding area defined by the mold 2 as shown by a position of assembly 48).

When rotated to the in-mold position, the assembly 48 uses a pick-up head 54 to pick up the container 5 positioned on a molding surface of the mold 2. The swing-arm assembly 48 is then rotated from the in-mold position (as shown by the position of the assembly 48 as depicted in FIG. 2) to the out-of-mold position (as shown by the position of the assembly 47 as depicted in FIG. 2). In this position, the assembly 47 holds the container 5 inline with the aperture 20 and when the container-mold set 4 and the lid-mold set 6 are moved (that is, the mold 2 is placed in the closed position), containers 5 held by swing-arm assemblies 47, 48 enter apertures 20, 22 respectively.

The swing-arm assemblies 57, 58 are actuatably rotatable about their pivot positions 59, 60. When the mold 2 is opened, the swing-arm assemblies 57, 58 are actuated to rotate one hundred and eighty degrees from an out-of-mold position (that is, a position that is outside the molding area of the mold 2 as shown by the position of assembly 57 as depicted in FIG. 2) to an in-mold position (that is, a position in the molding area as depicted by the position of assembly 58 in FIG. 2). A pick-up head 56 is in position to retrieve molded lid 7 from a lid core of the core plate 24. The swing-arm assemblies 57 and 58 are then actuatably rotated back one hundred and eighty degrees to the out-of-mold position. In this position, the lids 7 are aligned with apertures 38, 40 in the center manifold plate 18. When the assemblies 47, 48, 57 and 58 are all positioned in their out-of-mold positions, the mold 2 is closed and new containers 5 and new lids 7 are molded in the mold sets 4 and 6 respectively, and the lids 7 and containers 5 held by respective swing-arm assemblies are joined in the apertures 20, 38 and 22, 40; then containers joined to their lids are released down the chutes 15A, 15B created by internal ends 42, 44 and by internal ends 41, 43.

The swing-arm assemblies 57, 58 have rotated molded lids 7, and the swing-arm assemblies 47, 48 have rotated molded containers 5 one hundred and eighty degrees from their original positions in the mold 2 to an assembly-discharge position (that is, chutes 15A, 15B) preferably located in the mold 2.

Although the mold 2 is closed and molding material is injected into the container cavities and the lid cavities, the containers and the lids molded during a previous molding cycle are combined (connected, attached) to one another then they are released into chutes 15A, 15B. After the joined parts are released and new parts molded, the mold 2 is opened and the assemblies 47, 48, 57 and 58 are rotated one hundred and eighty degrees into their mold cavities to retrieve the next set of molded containers 5 and lids 7. Again, when the mold 2 closes, the molded containers 5 and lids 7 are connected to one another then released down the chutes 15A, 15B.

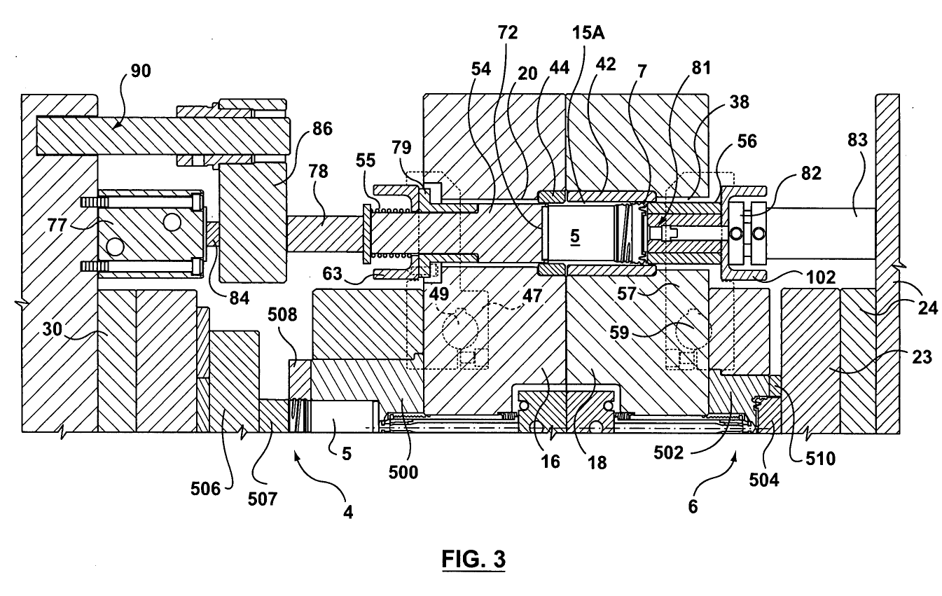

FIG. 3 is the detailed sectional view of the mold 2 and the assembly mechanism 3 of FIG. 1C, in which the mold 2 is placed in a mold-closed position. FIG. 3 shows schematically how the containers and the lids are brought together in the mold 2 then released into the chutes 15A, 15B of FIG. 1C.

As the mold 2 closes, the pick-up heads 54, 56 move the container 5 and the lid 7 into apertures 20, 38. The mold 2 closes due to a relative closing movement of the movable platen (not depicted) and center-manifold plates 16, 18 toward the core plate 24. When the mold 2 is fully closed, the container 5 engages the lid 7. A hydraulic cylinder 77 applies force which acts to a slidable push pillar 78 which drives the pick-up head 54 forwardly to force the container 5 into a full-threaded engagement with the lid 7. The container 5 becomes snap fitted with the lid 7. The motion of the push pillar 78 compresses a spring 55 against a bushing 79. When the container 5 and lid 7 are fully engaged, a vacuum is removed from a suction cup 72 (of FIG. 3) located at the end of the pick-up heads 54, 56, then the hydraulic cylinder 77 is retracted and the pick-up head 54 is retracted by spring 55, and the assembled lid and container are released into the guide chute 15A formed at the internal ends 42 and 44.

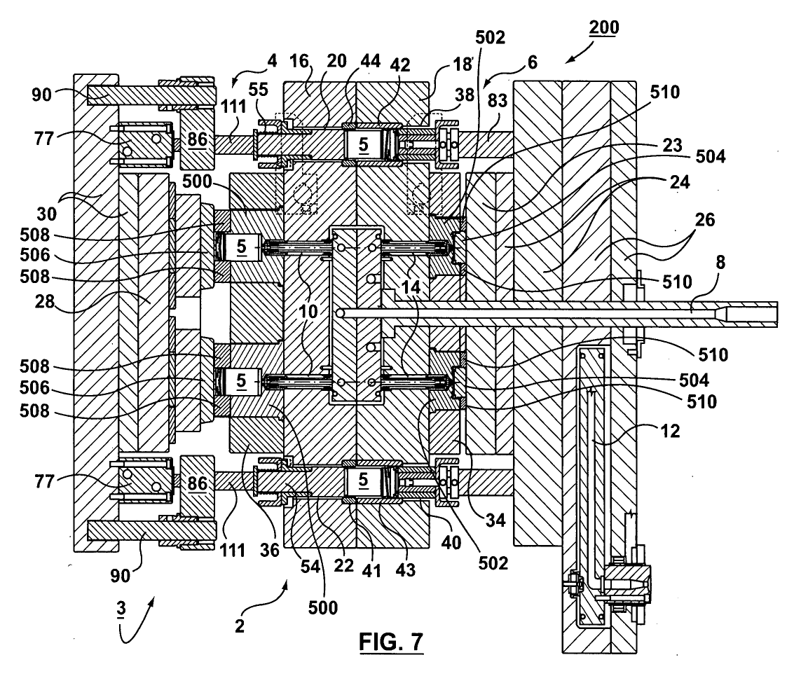

When the container and the lid are in position in the apertures formed in the mold 2, an in-mold snapping device (not depicted) is activated to force (that is, snap fit) the threads of the lid with the threads of the container. The snapping device includes a hydraulic shaft 84 that drives push pillar 78 that impels the spring-loaded pick-up head 54 toward the lid 7 and thus in this way the container is forced into snap engagement with the lid. Alignment between the threads of the containers and the threads of the lids is achieved by aligning the container and lid mold sets to appropriately orient start and finish of the threads of the containers and the lids. The suction cups 72, 81 and swing-arm assemblies 47, 57 keep the containers in their original orientation with respect to one another as the containers are removed from the mold 2 and placed in alignment with the lid. Preferably, the suction cups 72, 81 do not permit the containers and lids to rotate and the swing-arms assemblies 47, 57 keep the containers and lids in a horizontal plane. The threads on the container and the lid, when properly aligned, may flex enough to permit the lid to be tightly threaded onto the container without the need to torque them together. According to the first embodiment, the lids and the containers are snap-fitted together but they not torqued together, and the snap-fitted containers and lids are released into the chute 15A. According to the second embodiment (shown in FIG. 7), screwing (torquing) of the lid to the container is performed and the containers having screwed on lids are released into the chute 15A.

Each of the center manifold plates 16, 18 has apertures near their periphery. The number of apertures corresponds to the number of parts molded during a molding cycle. Centrally of the apertures is a downwardly-extending chute. When the parts (containers assembled to lids) are released, they are dropped down the chute. The dimensions of the chute are adjustable to accommodate different sizes of containers.

The swing-arm assembly 57 for the lids (shown in dotted lines in FIG. 3) is attached to the core plate 24. The assembly 57 rotates around pivot point 59 between a position in the lid-mold set 6 where the suction cup 81 on the pick-up head 56 is adjacent a molded lid 7 when the mold 2 is opened and a position where the suction cup 81 slides into the aperture 38 in the manifold plate 18 as the mold 2 closes. A pneumatic cylinder 82 mounted on the swing arm 57 provides suction to a suction cup 81 to hold the lid 7 while it is transferred from the mold cavity of the mold 2 to aperture 38 in the manifold plate 18. A support pillar 83 extending from the fixed core plate 24 provides backing support for a swing bracket 102 and swing-arm assembly 57 when the lid 7 is in the aperture 38, and this permits the lid 7 to resist forward movement of the container 5 and enables the container threads into a snap-fit engagement with the threads of the lid 7.

A spring-loaded head enables the container to be driven onto the lid. Hydraulic cylinder 77 has a shaft 84 that is pushable on guided clamp plate 86 to drive push pillar 78. The push pillar 78 abuts the end of the arm of the spring-loaded pick-up head 54 for the container 5 when the assembly 47 aligns the container 5 with the aperture 20 in the manifold plate 16. As the container 5 is moved to a position adjacent a lid 7, the spring 55 on the arm of the pick-up head 54 compresses as the container 5 abuts against the lid 7. When the mold 2 is closed, the hydraulic cylinder 77 is activated compressing the spring 55 and forcing the threads of the container 5 over the threads of the lid 7. When the container 5 is fully attached to the lid 7, the vacuum applied to the suction cups on the end of the pick-up heads 54 and 56 is removed and the hydraulic cylinder 77 retracts the push pillar 78. This action releases the assembled container 5 and lid 7 so the assembly can fall freely down the guide chutes 15A or 15B created at the internal ends 42 and 44 to a receiving area outside the mold 2.

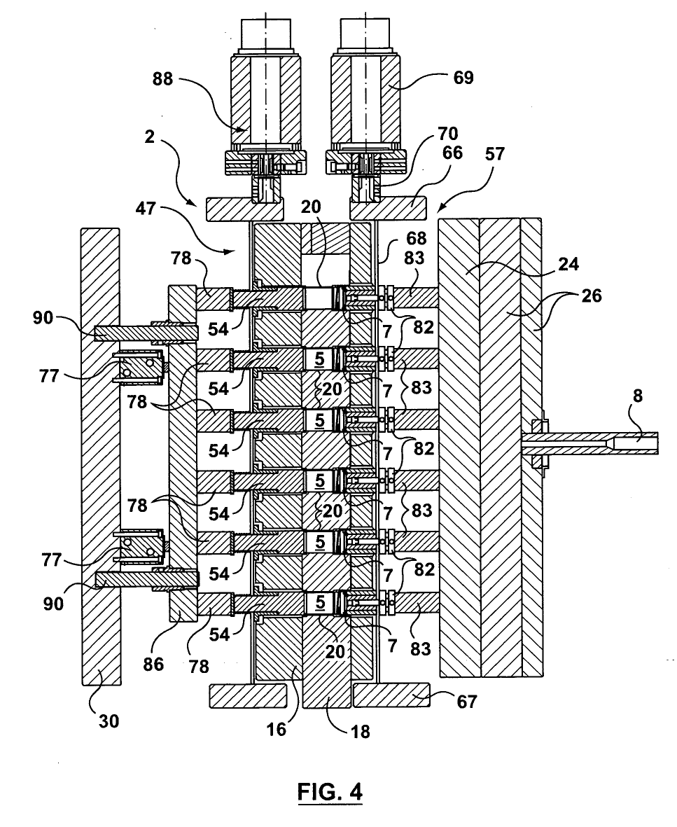

FIG. 4 is the sectional elevation view of the mold 2 of FIG. 1C. Six containers 5 are vertically aligned in apertures 20 in the manifold plate 18. Each container 5 abuts a lid 7 in preparation for assembling the containers with the lids. A pair of hydraulic cylinders 77 push the guided clamp plate 86 to move the push pillars 78 adjacent each spring-loaded, pick-up head 54 which propels the containers 5 into assembled position with the lids 7. Servo motors 88 and 69 rotate the assemblies 47, 57 between a component assembling position (as shown in FIG. 4 with the mold 2 in the closed position) and a component pick-up position when the mold 2 is in the opened position (as shown in FIG. 2). Leader pins 90 are used to guide clamp plate 86.

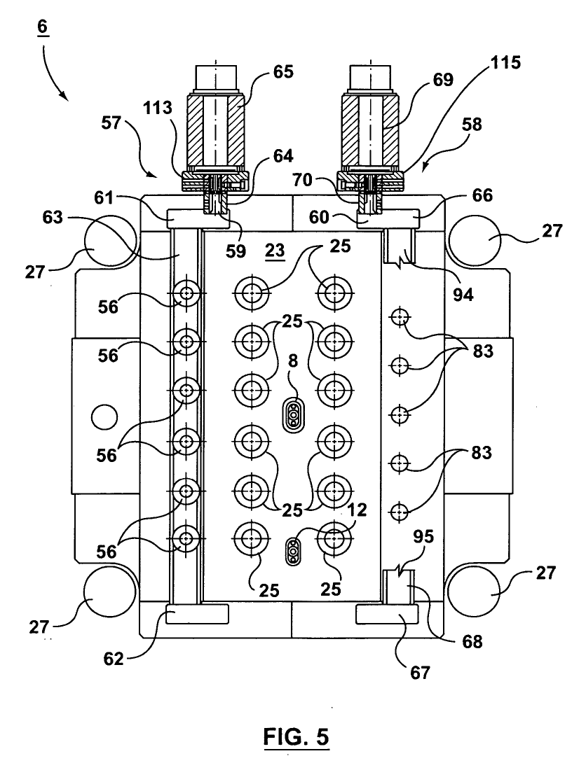

FIG. 5 is the partial end view of the lid-mold set 6 of the mold 2 of FIG. 1C. The swing-arm assemblies are rotated by servo motors for rapid and accurate retrieval of parts from the mold 2. Lid cores 25 extend from the mold 2. Tie bars 27 extend across the mold 2 to help clamp the mold. The support pillars 83 provide support for the swing brackets 63 and 68 when the swing brackets are aligned in the part assembly position (as shown in FIG. 5).

As shown in FIG. 5, the swing-arm assembly 57 includes an upper swing arm 61 and a lower swing arm 62. A swing bracket 63 extends between swing arms 61, 62 and includes a plurality of pick-up heads 56. The number of pick-up heads 56 is determined by the number of lid cavities within a column of the lid-mold set 6. In the shown embodiment there are 6 lid cavities in each column of the lid-mold set 6. A servomotor 65 is mounted on the center manifold plate 18 by motor mount 113 and has its output shaft 64 attached to the upper swing arm 61 at the pivot position 59. The motor 65 drives the upper swing arm 61 through one hundred and eighty degrees of rotation to rotate the swing bracket 63 to a position in the open mold so pick-up heads 56 can retrieve lids 7 and a position where the pick-up heads 56 can enter the aperture 38 (of FIG. 3) when the mold closes. The swing bracket 63 rotates about the pivot position 59 midway between the centerline for the lid cavity and the centerline of the aperture 38 (of FIG. 3). Similarly, the swing-arm assembly 58 includes an upper swing arm 66 and a lower swing arm 67. A swing bracket 68 extends between swing arms 66, 67 and includes a plurality of pick-up heads (not shown). A portion of the swing bracket 68 has been cut out between the cut lines 94 and 95 of FIG. 5 to show the positioning of the support pillars 83. A servomotor 69 is mounted on the center manifold plate 18 (of FIG. 3) by a motor mount 115 and has its output shaft 70 attached to the upper swing arm 66 at the pivot position 60. The motor 69 drives the upper swing arm 66 through one hundred and eighty degrees of rotation to rotate the swing bracket 68 to a position in the open mold so pick-up heads 56 (see FIGS. 1 and 2) can retrieve the lids and a position where the pick-up heads 56 can enter the aperture 40 (of FIG. 1C) when the mold closes. The swing bracket 68 rotates about the pivot position 60 midway between the centerline for the lid cavity and the centerline of the aperture 40 (of FIG. 1C).

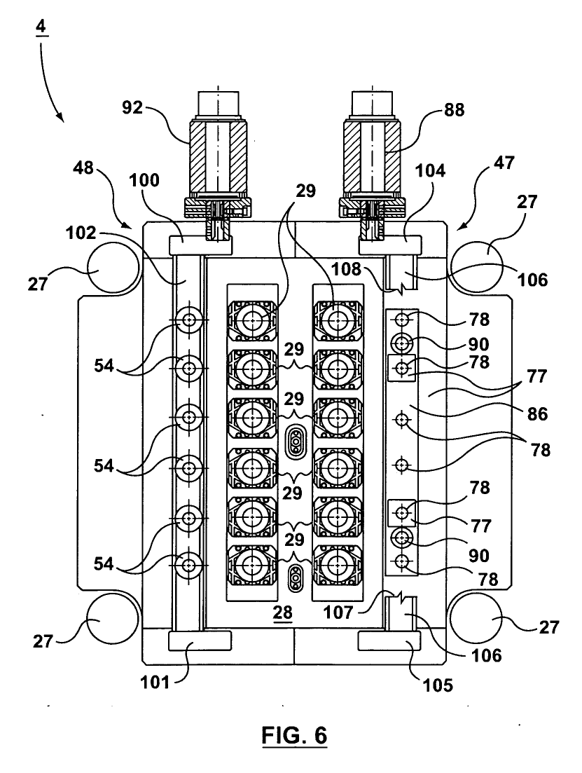

FIG. 6 is a partial end view of the container-mold set 4 of the mold 2 of FIG. 1C. Container cores 29 extend from container core plate 30 (of FIG. 1C). Servomotors 88 and 92 drive swing-arm assemblies 47 and 48 to remove containers from the container cores 29 and align them with the openings in the center manifold plate 16 (of FIG. 1C). The swing-arm assembly 48 includes an upper swing arm 100, a lower swing arm 101 and a swing bracket 102. The pick-up heads 54 are attached to the swing bracket 102 and are rotated by the servo motor 92 into a position to remove containers from the container cores 29 and return with the containers to a position aligned with the apertures 22 (of FIG. 1C) in the center manifold plate 16 (of FIG. 1C). The swing-arm assembly 47 includes an upper swing arm 104, lower swing arm 105 and swing bracket 106. The bracket 106 is shown cut away at lines 108 and 107 to better show the structure behind the swing brackets. As shown, a push pillar 78 is provided behind each pick-up head 54 on the swing brackets 102 and 106.

The swing-arm assemblies 47 and 48 for the containers 5 are attached to the container stripper plate 28 attached to the container core plates 30 and are pivoted about a point midway between the centerline for the container cavities in the container cavity plates 36 (of FIG. 1C) and the centerline for the apertures 20 and 22 (of FIG. 1C).

Swing arms 47, 48 include pick-up heads 54. Each pick-up head 54 is biased by the spring 55 (of FIG. 2). A suction cup 72 is provided at a distal end of each pick-up head 54. The molded containers are held on the end of the swing arms 47, 48 by suction force applied by suction cups at a distal end of the spring-loaded, pick-up heads 54. The lids are held firmly on the end of the assemblies 47, 48 by suction cup 72.

Operation

Referring to FIGS. 2 and 3, the assembly and release of the container and lids is illustrated. FIG. 2 illustrates schematically the removal of the molded parts from the cores of the mold when the mold is open. As shown by the arrow 74 at the bottom left of FIG. 2, the swing arm 48 is rotated one hundred and eighty degrees into position at the base of the container 5. Vacuum is supplied to the spring-loaded, pick-up head 54 and the container 5 is then held by the head 54. The swing arm 47 rotates one hundred and eighty degrees to move the container 5 through the positions schematically shown in the top left of FIG. 2 to a position aligned with the aperture 20 in the center manifold plate 16. The swing arm assemblies 57, 58 are similarly rotated into position to pick up the lids, and then are rotated to a position aligned with the apertures 38, 40.

In the top left portion of mold 2 in FIG. 2, the travel of a container 5 is illustrated. The container 5 has been withdrawn from the container cavity in the container cavity plate 36 and initially held on the container core 29. The swing arm 47 rotates the pick-up head 54 into position adjacent the container 5 as indicated by arrow 75. The container 5 is attached to the suction cup 72 on the end of pick-up head 54. The container 5 is then rotated through the illustrated intermediate positions to the position shown in FIG. 2 where the container 5 is aligned with the aperture 20. The bottom left portion of mold 2 in FIG. 2 shows a pick-up head 54 in position to retrieve a container 5 from the container stripper plate 28. In operation, the assemblies 47, 48 would rotate into and out of the mold set 4 in unison so that all the containers 5 molded during a molding cycle would be retrieved during the same succeeding molding cycle. FIG. 2 has been modified to better illustrate the embodiment.

The right portion of mold 2 in FIG. 2, illustrates the travel of the lids. The lids are retrieved from the mold 2 by pick-up heads 56 on swing arm assemblies 57, 58. The lids 7 are also held on the pick-up heads 56 by suction cups attached to the pick-up heads 56. Again, the swing-arm assemblies 57, 58 operate in unison to simultaneously remove the lids 7 from the mold.

FIG. 7 is the sectional view of the mold 200 and the assembly mechanism 300 usable with the molding machine 202 of FIG. 1A, according to the second embodiment. The second embodiment is the preferred embodiment. According to the second embodiment, the push pillars 78 are of the first embodiment are replaced with a pneumatic-drive motor 111 that actuatably rotates containers 5 relative to lids 7.

In an alternative, it is contemplated that any type of motor that provides controllable torque, such as an electric motor, is used. These motors enable the container 5 to be rotated onto the lid 7 by using to a predetermined torque force. Although controlling the torque force may be desirable sometimes, including the torquing motors with the mold 2 may create an added expense to the molding machine 202. In an alternative, the torquing devices are used downstream of the chutes 15A, 15B (of FIG. 1C) to torque the containers to the lids, and this arrangement could require that the containers and the lids are partly assembled in the mold envelope (that is, they are snap fitted together before they are released into chutes 15A, 15B) and the snap-fitted parts arrive at the torquing device for subsequent torquing operation.

The above alternative describes an embodiment in which a motor is used to torque the container to the lid while the container and the lid are in a molding envelope. It is contemplated to use a gripping means (as a substitute for holding the containers and the lid with suction cups). The gripper means grips the container and the lids so that when torque is supplied the container and the lid will not slip (substantially) with respect to their holding devices.

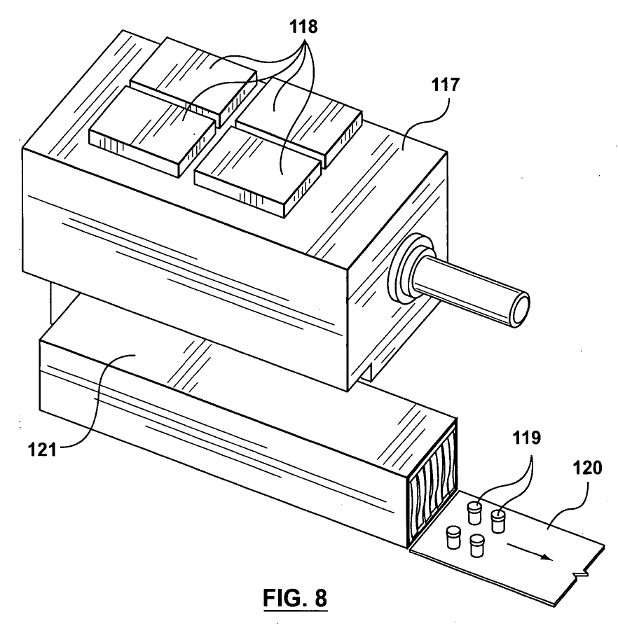

FIG. 8 is a perspective of the molding machine 202 of FIG. 1A. Depicted is a molding-machine cabinet 117 with HEPA filters 118 mounted on a top wall of the molding-machine cabinet 117. Assembled containers and lids 119 are dropped down the chutes 15A, 15B and onto a conveyor 120 extending from a housing 121. The exit of the housing 121 is covered to prevent a flow of contaminated air into the conveyor housing 121 and the molding-machine cabinet 117 but is resilient enough that the cover does not interfere with the movement of assembled units containers and lids on the conveyor 120. With this arrangement, the HEPA filters 118, when actuated, filter the air entering the sterilization envelope and thereby ensure that the molded assembled containers 119 are kept sterile while eliminating a need to maintain a sterile environment outside the molding envelope or to perform a subsequent decontamination operation of the container and lid at a subsequent station.

In an alternative, the environment in the mold is kept sterile using another approach. The HEPA filters are replaced by ultraviolet lamps or by a sterilizing-gas generator could be used to feed sterilizing gas (or air) into the sterilization envelope. Preferably, the sterilizing envelope is substantially sealed and exiting gas is recaptured.

In an alternative embodiment, another closure means is contemplated for a container and a lid (other than a threaded means described above). According to an alternative, the lid and the container mate using a bayonet type interconnect means (that is, a palm ‘n’ turn style for example) used for drug vials. According to another embodiment, the lid and the container do not mate with an interconnecting means but rather the lid slides onto the container. According to yet another embodiment, the lid or the container includes a detent that permits the lid to snap fit onto the container. Generally, the aspect that is common between the embodiments and alternatives is that the second part is interlockable with the first part.

In an, alternative embodiment, the assembly mechanism 3 is configured to interlock the first part with the second part. The above detailed description has provided examples of interlocking the first part with the second part (threads on the parts, etc).

In an alternative, the swing-arm assemblies 47 or 48 are configured to pick up, swing, align and translate the first part toward the second part. The swing-arm assemblies 5 or 58 are configured to pick up, swing, align and translate the second part toward the first part. It is contemplated that any combination and permutation thereof of these assemblies 47, 48, 57, 58 may be used.

In an alternative embodiment, sterilization of the container and the lid is not needed, and therefore the system 200 of FIG. 1 C includes the molding system 202 and the assembly mechanism 3 and the sterilization mechanism 210 is excluded because sterilization is not needed.

The embodiments described above that include the sterilization mechanism 210 are classified as prophetical embodiments or prophetical alternatives (even though the description above was written in the past tense). The embodiments or alternatives described that do not include the sterilization mechanism 210 are classified as working embodiments or working alternatives (such as the embodiments and/or alternatives related to the mold 2, the assembly mechanism 3 and the molding machine 202.

The description of the exemplary embodiments provides examples of the present invention, and these examples do not limit the scope of the present invention. It is understood that the scope of the present invention is limited by the claims. The embodiments described above may be adapted for specific conditions and/or functions, and may be further extended to a variety of other applications that are within the scope of the present invention. Having thus described the embodiments and alternatives, modifications and enhancements are possible without departing from the concepts as described. Therefore what will be protected by way of letters patent are limited only by the scope of the following claims:

What is claimed is:

1. A system, comprising:
a molding machine configured to cooperate with a mold to mold a first part and a second part, the second part interlockable with the first part, the second part molded separately from the first part; and
an assembly mechanism configured to interlock the first part with the second part.

2. The system of claim 1, wherein:
the first part defines a first thread configured to interactively thread with a second thread defined by the second part; and
the assembly mechanism is configured to interlock the first thread of the first part relative to the second thread of the second part.

3. The system of claim 1, wherein
the assembly mechanism is configured to any one of:
snap fit the first part relative to the second part;
torque the first part relative to the second part; and
any combination and permutation thereof.

4. The system of claim 1, wherein the assembly mechanism includes any one of:
a first swing-arm assembly configured to pick up, swing, align and translate the first part toward the second part;
a second swing-arm assembly configured to pick up, swing, align and translate the second part toward the first part; and
any combination and permutation thereof.

5. The system of claim 1, wherein the assembly mechanism is configured to be operatively connectable to any one of:
the mold;
an end-of-arm-tool of a robot; and
any combination and permutation thereof.

6. The system of claim 1, wherein the first part the second part are configured to:
be a container and a lid respectively, the lid usable for covering the container; and
be a urine-sample collection container and a cap respectively, the cap usable for covering the urine-sample collection container.

7. The system of claim 1, wherein
the assembly mechanism is configured to:
cooperate with a sterilization mechanism having a sterilization envelope, the sterilization mechanism configured to maintain, in association with a molding-machine envelope of the molding machine, the first part and the second part sterilized; and
interlock, in association with the sterilization envelope, the first part with the second part.

8. The system of claim 7, wherein the sterilization mechanism is configured to impose a sterile condition upon the molding-machine envelope.

9. The system of claim 7, wherein the sterilization mechanism includes any one of:
an ultraviolet lamp configured to direct ultraviolet light toward, at least in part, the first part and the second part;
a sterilized-air mover configured to move sterilized air toward, at least in part, the first part and the second part;
a clean-room enclosure configured to substantially prevent an ingress of bacteria, as least in part, into the molding-machine envelope, the sterilization envelope and any combination and permutation thereof;
a clean-room barrier configured to substantially prevent an ingress of bacteria, at least in part, into the molding-machine envelope, the sterilization envelope and any combination and permutation thereof;
an air mover configured to move air, the moved air substantially displacing bacteria, at least in part, away from the first part and the second part; and
any combination and permutation thereof.

10. The system of claim 7, wherein the molding-machine envelope is configured to any one of:
overlap the sterilization envelope in part;
not overlap the sterilization envelope;
exist within the sterilization envelope; and
permit the sterilization envelope to exist within the molding-machine envelope.

11. A system, comprising:
a molding machine configured to:
cooperate with a mold to mold a first part and a second part, the second part interlockable with the first part, the second part molded separately from the first part;
cooperate with an assembly mechanism, the assembly mechanism configured to interlock the first part with the second part.

12. The system of claim 11, wherein:
the first part defines a first thread configured to interlock with a second thread defined by the second part; and
the assembly mechanism is configured to interlock the first thread of the first part relative to the second thread of the second part.

13. The system of claim 11, wherein
the assembly mechanism is configured to any one of:
snap fit the first part relative to the second part;
torque the first part relative to the second part; and
any combination and permutation thereof.

14. The system of claim 11, wherein the assembly mechanism includes any one of:
a first swing-arm assembly configured to pick up, swing, align and translate the first part toward the second part;
a second swing-arm assembly configured to pick up, swing, align and translate the second part toward the first part; and
any combination and permutation thereof.

15. The system of claim 11, wherein the assembly mechanism is configured to be operatively connectable to any one of:
the mold;
an end-of-arm-tool of a robot; and
any combination and permutation thereof.

16. The system of claim 11, wherein the first part the second part are configured to:
be a container and a lid respectively, the lid usable for covering the container; and
be a urine-sample collection container and a cap respectively, the cap usable for covering the urine-sample collection container.

17. The system of claim 11, wherein
the assembly mechanism is configured to:
cooperate with a sterilization mechanism having a sterilization envelope, the sterilization mechanism configured to maintain, in association with a molding-machine envelope of the molding machine, the first part and the second part sterilized; and
interlock, in association with the sterilization envelope, the first part with the second part.

18. The system of claim 17, wherein the sterilization mechanism is configured to impose a sterile condition upon the molding-machine envelope.

19. The system of claim 17, wherein the sterilization mechanism includes any one of:
an ultraviolet lamp configured to direct ultraviolet light toward, at least in part, the first part and the second part;
a sterilized-air mover configured to move sterilized air toward, at least in part, the first part and the second part;
a clean-room enclosure configured to substantially prevent an ingress of bacteria, as least in part, into the molding-machine envelope, the sterilization envelope and any combination and permutation thereof;
a clean-room barrier configured to substantially prevent an ingress of bacteria, at least in part, into the molding-machine envelope, the sterilization envelope and any combination and permutation thereof;
an air mover configured to move air, the moved air substantially displacing bacteria, at least in part, away from the first part and the second part; and
any combination and permutation thereof.

20. The system of claim 17, wherein the molding-machine envelope is configured to any one of:
overlap the sterilization envelope in part;
not overlap the sterilization envelope;
exist within the sterilization envelope; and
permit the sterilization envelope to exist within the molding-machine envelope.

21. A system, comprising:
an assembly mechanism configured to interlock a first part with a second part, the first part and the second part molded by a molding machine configured to cooperate with a mold to mold the first part and the second part, the second part interlockable with the first part, the second part molded separately from the first part;

22. The system of claim 21, wherein:
the first part defines a first thread configured to interlock with a second thread defined by the second part; and
the assembly mechanism is configured to interlock the first thread of the first part relative to the second thread of the second part.

23. The system of claim 21, wherein
the assembly mechanism is configured to any one of:
snap fit the first part relative to the second part;
torque the first part relative to the second part; and
any combination and permutation thereof.

24. The system of claim 21, wherein the assembly mechanism includes any one of:
a first swing-arm assembly configured to pick up, swing, align and translate the first part toward the second part;
a second swing-arm assembly configured to pick up, swing, align and translate the second part toward the first part; and
any combination and permutation thereof.

25. The system of claim 21, wherein the assembly mechanism is configured to be operatively connectable to any one of:
the mold;
an end-of-arm-tool of a robot; and
any combination and permutation thereof.

26. The system of claim 21, wherein the first part the second part are configured to:
be a container and a lid respectively, the lid usable for covering the container; and
be a urine-sample collection container and a cap respectively, the cap usable for covering the urine-sample collection container.

27. The system of claim 21, wherein
the assembly mechanism is configured to:
cooperate with a sterilization mechanism having a sterilization envelope, the sterilization mechanism configured to maintain, in association with a molding-machine envelope of the molding machine, the first part and the second part sterilized; and
interlock, in association with the sterilization envelope, the first part with the second part.

28. The system of claim 27, wherein the sterilization mechanism is configured to impose a sterile condition upon the molding-machine envelope.

29. The system of claim 27, wherein the sterilization mechanism includes any one of:
an ultraviolet lamp configured to direct ultraviolet light toward, at least in part, the first part and the second part;
a sterilized-air mover configured to move sterilized air toward, at least in part, the first part and the second part;
a clean-room enclosure configured to substantially prevent an ingress of bacteria, as least in part, into the molding-machine envelope, the sterilization envelope and any combination and permutation thereof;
a clean-room barrier configured to substantially prevent an ingress of bacteria, at least in part, into the molding-machine envelope, the sterilization envelope and any combination and permutation thereof;
an air mover configured to move air, the moved air substantially displacing bacteria, at least in part, away from the first part and the second part; and
any combination and permutation thereof.

30. The system of claim 27, wherein the molding-machine envelope is configured to any one of:
overlap the sterilization envelope in part;
not overlap the sterilization envelope;
exist within the sterilization envelope; and
permit the sterilization envelope to exist within the molding-machine envelope.

31. A system, comprising:
a sterilization mechanism configured to:
have a sterilization envelope,
maintain, in association with a molding machine-envelope of a molding machine, a first part and a second part sterilized, the molding machine configured to cooperate with a mold to mold the first part and the second part, the second part interlockable with the first part, the second part molded separately from the first part, and
cooperate with an assembly mechanism configured to interlock, in association with the sterilization envelope, the first part with the second part.

32. The system of claim 31, wherein:
the first part defines a first thread configured to interlock with a second thread defined by the second part; and
the assembly mechanism is configured to interlock the first thread of the first part relative to the second thread of the second part.

33. The system of claim 31, wherein
the assembly mechanism is configured to any one of:
snap fit the first part relative to the second part;
torque the first part relative to the second part; and
any combination and permutation thereof.

34. The system of claim 31, wherein the assembly mechanism is configured to interlock the first part with the second part within the molding-machine envelope.

35. The system of claim 31, wherein the assembly mechanism includes:
a first swing-arm assembly configured to pick up and handle the first part (206); and
a second swing-arm assembly configured to pick up and handle the second part.

36. The system of claim 31, wherein the assembly mechanism is configured to be operatively connectable to any one of:
the mold;
an end-of-arm-tool of a robot; and
any combination and permutation thereof.

37. The system (200) of claim 31, the sterilization mechanism (210) is configured to impose a sterile condition upon the molding-machine envelope.

38. The system of claim 31, wherein the sterilization mechanism includes any one of:
an ultraviolet lamp configured to direct ultraviolet light toward, at least in part, the first part and the second part;
a sterilized-air mover configured to move sterilized air toward, at least in part, the first part and the second part;
a clean-room enclosure configured to substantially prevent an ingress of bacteria, as least in part, into the molding machine-envelope, the sterilization envelope and any combination and permutation thereof;
a clean-room barrier configured to substantially prevent an ingress of bacteria, at least in part, into the molding-machine envelope, the sterilization envelope and any combination and permutation thereof;
an air mover-configured to move air, the moved air substantially displacing bacteria, at least in part, away from the first part and the second part; and
any combination and permutation thereof.

39. The system of claim 31, wherein the first part the second part are configured to:
be a container and a lid respectively, the lid usable for covering the container; and
be a urine-sample collection container and a cap respectively, the cap usable for covering the urine-sample collection container.

40. The system of claim 31, wherein the molding machine-envelope is configured to any one of:
overlap the sterilization envelope at least in part;
not overlap the sterilization envelope;
exist within the sterilization envelope; and
permit the sterilization envelope to exist within the molding machine-envelope.
